(19) United States
(12) Patent Application Publication
(10) Pub. No.: US 2011/0273684 A1
(43) Pub. Date: Nov. 10, 2011

(54) NANO-IMPRINT METHOD AND APPARATUS

(75) Inventors: Soichi OWA, Kumagaya (JP); Masaomi KAMEYAMA, Tokyo (JP)

(73) Assignee: NIKON CORPORATION, Tokyo (JP)

(21) Appl. No.: 12/967,707

(22) Filed: Dec. 14, 2010

Related U.S. Application Data
(63) Continuation of application No. PCT/JP2009/002503, filed on Jun. 3, 2009.

(30) Foreign Application Priority Data
Jun. 17, 2008 (JP) 2008-158345
Jun. 18, 2008 (JP) 2008-158815

(51) Int. Cl. G03B 27/42

(52) U.S. Cl. 355/53

(57) ABSTRACT

There is provided a nanoimprint method for pressing a template having a pattern of a rugged or uneven shape, to a substrate coated with a curable resin the method including a measuring step for measuring positions of preselected sample measurement points of a predetermined number, which are set for object regions, respectively, of the substrate; a calculating step for performing statistical operations using the measurement positions of the sample measurement points as operation parameters thereby to calculate the deformed states of the object regions; a deforming step for deforming the template based on the deformed states of the object regions calculated at the calculating step; and a pressing step for pressing the deformed template onto the object regions. Accordingly, a nanoimprint method and a nanoimprint apparatus capable of forming a pattern highly precisely on a substrate are provided.

### FIELD OF THE INVENTION

The present invention relates to a nanoimprint technique.

### BACKGROUND ART

In recent years, semiconductor integrated circuits have been becoming finer and more integrated, and a move toward higher precision of photolithography apparatuses, as the pattern transfer technique for realizing those fine processes, has been progressing. In order to further advance miniaturization and higher precision, technology relating to photolithography techniques has been proposed. For example, Patent Document 1 discloses a nanoimprint technique that transfers a prescribed pattern by stamping a template having an uneven pattern that is inverted with respect to the pattern desired to be formed on the substrate to a curable resin formed on the surface of the substrate.

In the case in which a nanoimprint technique is used to perform manufacture of electronic devices such as semiconductor devices, it is necessary to stamp the template to correspond to pattern regions that have been formed in advance on a substrate such as a silicon wafer to form a new pattern. In this regard, Patent Document 2 discloses a technique relating to alignment of a template and a substrate.

In addition, defects are sometimes produced in the pattern transferred to the substrate due to the fact that gas bubbles resulting from the air, etc. remain between the template and the substrate when the template is stamped to the substrate. In this regard, Patent Document 3 discloses a technique of reducing the pressure of the space between the template and the substrate in stamping the template to the substrate.

[PATENT LITERATURE 1]: U.S. Pat. No. 5,772,905

[PATENT LITERATURE 2]: Japanese Unexamined Patent Application Laid-open No. 2007-200953

[PATENT LITERATURE 3]: Japanese Unexamined Patent Application Laid-open No. 2007-134368

### DISCLOSURE OF INVENTION

### Problems to Be Solved by the Invention

In the electronic device manufacturing process, the pattern region formed on the substrate is sometimes deformed from the prescribed shape due to the substrate being heat treated. In the technique disclosed in Patent Document 2, it is not possible to accurately perform imprinting with respect to the deformed pattern region, so there are cases in which it is not possible to form a pattern on the substrate with high accuracy.

In addition, in the technique disclosed in Patent Document 3, there is danger of it not being possible to reliably eliminate gas bubbles that remain between the template and the substrate when stamping the template to the substrate. In the case in which gas bubbles cannot be eliminated, it is not possible to form a pattern on the substrate with high accuracy, since defects are produced in the pattern transferred to the substrate.

The purpose of the modes of the present invention is to provide a nanoimprint method and a nanoimprint apparatus that are able to form a pattern on a substrate with high accuracy.

### Solution to Problem

A nanoimprint method according to a first aspect of the present invention is a method for pressing a template, on which a pattern with an uneven shape is formed, to a substrate coated with a curable resin. Further, the nanoimprint method comprises a measuring step for measuring positions of a prescribed number of sample measurement points selected in advance from among measurement points set in regions to be processed of the substrate, respectively; a calculating step for performing statistical operations with the measurement positions of the sample measurement points as operation parameters and calculating deformation states of the regions to be processed; a deforming step for deforming the template based on the deformation states of the regions to be processed calculated in the calculating step; and a pressing step for pressing the deformed template to the regions to be processed.

A nanoimprint method according to a second aspect of the present invention is for pressing a template, on which a pattern with an uneven shape is formed on a first surface of the template, to a substrate coated with a curable resin. This nanoimprint method comprises a heat deforming step for thermally deforming the template so as to conform to regions to be processed of the substrate; and a pressing step for pressing the thermally deformed template and the regions to be processed with each other.

A nanoimprint apparatus according to a third aspect of the present invention presses a template, having a pattern with an uneven shape formed on a first surface thereof, to a substrate coated with a curable resin. This nanoimprint apparatus comprises a heating means for heating prescribed regions of a second surface which is opposite to the first surface; and a pressing part which presses the pattern with the uneven shape, of the template which has been heated and thermally deformed, and regions to be processed of the substrate.

A nanoimprint apparatus according to a fourth aspect of the present invention comprises a template on which an uneven pattern is formed; a substrate mounting table which is arranged to face the template and on which a substrate coated with a liquid resin is mounted; a pressing part which brings closely the template and the substrate in contact with each other and which presses at least one of the template and the substrate so that the resin is molded to the uneven pattern; and a gas supply part which supplies gas, dissolving easily in the resin, when the template and the substrate are made to approach closely to each other by the pressing part, the gas being supplied to at least between the template and the substrate which faces the template.

A nanoimprint method according to a fifth aspect of the present invention comprises a template on which an uneven pattern is formed; a substrate mounting table which is arranged to face the template and on which a substrate coated with a liquid resin is mounted; a pressing part which brings closely the template and the substrate into contact with each other and which presses at least one of the template and the substrate so that the resin is molded to the uneven pattern; and a chamber in which a gas dissolving easily in resin is filled and which accommodates the template and the substrate.

A nanoimprint method according to a sixth aspect of the present invention is a nanoimprint method for transferring, to a substrate, an uneven pattern formed on a template, the method comprising: a coating step for coating a liquid resin to the substrate; a supply step for supplying a gas, which dissolves easily in the resin, in the vicinity of the liquid resin; and a pressing step for pressing at least one of the template and the substrate so as to mold the resin to the uneven pattern.

A nanoimprint method according to a seventh aspect of the present invention is a nanoimprint method for transferring, to a substrate, an uneven pattern formed on a template, the method comprising: a coating step for coating a liquid resin to the substrate; a supply step for supplying a gas, which dissolves easily in resin, into a chamber; and a pressing step for pressing at least one of the template and the substrate so as to mold the resin to the uneven pattern.

### Effects of the Invention

According the aspects of the present invention, it is possible to form a pattern on a substrate with high accuracy.

### BRIEF DESCRIPTION OF THE DRAWINGS

FIG. 1 is a schematic view that shows a first nanoimprint apparatus 100.

FIG. 2 is a schematic view that shows the details of an alignment camera CA of the first embodiment.

FIG. 3(a) is a drawing for describing an example of alignment mark AM plurally formed on the wafer SW. FIG. 3(b) is a drawing of a state in which an image of an alignment mark AM has been resolved on an index plate 66.

FIG. 4 is a drawing in which the nanoimprint method of the first embodiment is described.

FIG. 5 is a drawing in which the nanoimprint method of the first embodiment is described.

FIG. 6 is a drawing that depicts an optical fiber bundle 30, which is built into a holding part 50, which holds a template TP, along with the template TP.

FIG. 7 is a drawing that shows a switch 33 of an optical fiber 31.

FIG. 8 is a schematic view that shows the procedure by which the optical fiber bundle 30 thermally deforms the template TP.

FIG. 9 is a side surface schematic view that depicts a spatial light modulation part SLM built into the holding part 50, which holds the template TP, along with the template TP.

FIG. 10 is a flow chart from EGA measurement of alignment marks AM of the wafer SW up to curing of a resin 21.

FIG. 11 is a drawing in which the nanoimprint methods of the second and third embodiments are described.

FIG. 12 is a drawing in which the nanoimprint methods of the second and third embodiments are described.

FIG. 13 is a schematic view that shows a second nanoimprint apparatus 200.

FIG. 14 is a flow chart of the operation sequence of the second nanoimprint apparatus 200.

FIG. 15 is an enlarged schematic view of the vicinity of a gas supply part 41, a dispenser 57 and the template TP and is a drawing that shows Modification Example 3.

FIG. 16 is an enlarged schematic view of the vicinity of the gas supply parts 41, the dispensers 57 and the template TP and is a drawing that shows Modification Example 4.

FIG. 17 is a schematic view that shows a third nanoimprint apparatus 250.

### BEST MODE FOR CARRYING OUT THE INVENTION

### First Embodiment

### First Nanoimprint Apparatus 100

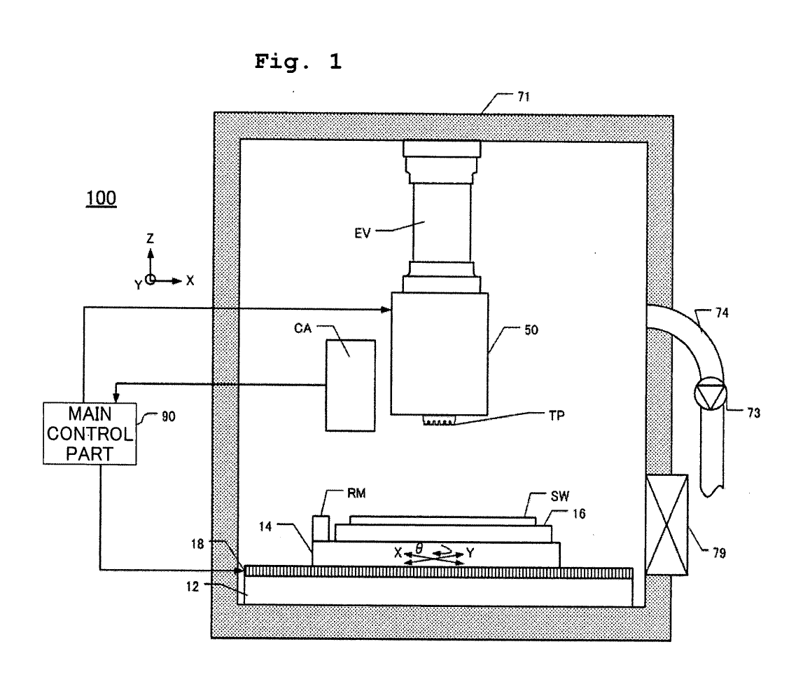

FIG. 1 is a schematic view that shows a first nanoimprint apparatus 100. The first nanoimprint apparatus 100 is able to transfer an uneven pattern of a template TP to the wafer SW as the substrate, and transfer is performed within a chamber 71 as shown in FIG. 1. Note that the wafer SW is such that, for example, a silicon wafer is used, but it is not limited to this, and it is also possible to make it a glass substrate, a ceramic substrate, etc.

The first nanoimprint apparatus 100 has a holding part 50, which holds the template TP. The template TP is supported by a press elevator EV. This press elevator EV is attached to the ceiling of the chamber 71 of the first nanoimprint apparatus 100. The press elevator EV is able to move the template TP in the Z directions (vertical directions). The press elevator EV causes the template TP and the wafer SW to approach each other and is able to transfer an uneven pattern to a curable resin that has been formed on the wafer SW.

On the other hand, the wafer SW is fixed by vacuum chucking or electrostatic chucking by means of a chucking table 16. This chucking table 16 is supported on a stage 14. The stage 14 is able to move in the X axis directions and the Y axis directions and is also able to rotate centering on the Z axis. The stage 14 is such that movement is possible at a maximum stroke of, for example, approximately 200 mm in the X axis and Y axis directions. The stage 14 is such that a reference mirror RM that extends in the X axis directions and the Y axis directions is fixed to a part thereof. A linear motor 18 is provided on the stage 14, and the linear motor 18 drives the stage 14 in the X axis and Y axis directions. The stage 14 is mounted on a vibration isolating table 12 so as not to be subject to the effects of external vibration.

Note that, in FIG. 1, the configuration is such that the template TP moves vertically by means of the press elevator EV, and the wafer SW is mounted on the stage 14 and moves in the X axis and Y axis directions, but the configuration may also be such that the template TP moves in the X axis and Y axis directions, and the wafer SW moves vertically by means of the press elevator.

The chamber 71 of the first nanoimprint apparatus 100 has an exhaust pipe 74 at a part thereof, and a depressurizing pump 73 is connected to that exhaust pipe 74. The interior of the chamber 71 is in a state in which the pressure has been reduced to below atmospheric pressure. In addition, the chamber 71 has a load lock gate 79, and the wafer SW can be loaded into the first nanoimprint apparatus 100 and unloaded to outside the first nanoimprint apparatus 100. Note that the interior of the chamber 71 may also be at the same gas pressure as atmospheric pressure.

The wafer SW is aligned (positioned) by means of an alignment camera CA provided on the first nanoimprint apparatus 100.

### EGA (Enhanced Global Alignment) By Means of the Alignment Camera CA

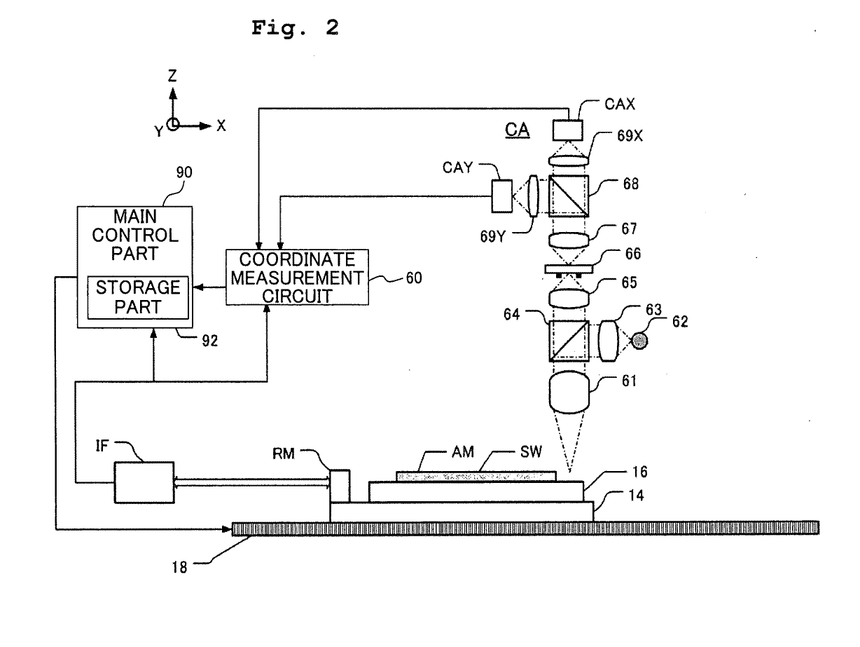

FIG. 2 is a schematic view that shows the details of the alignment camera CA of the first embodiment. The wafer SW is loaded onto the two-dimensionally positioned XY stage 14. A reference mirror RM is fixed to the end part of the upper surface of the stage 14, and a laser interferometer IF is arranged so as to oppose (to be opposite or facing) the reference mirror RM. Note that a drawing has been omitted in FIG. 2, but the reference mirror RM is comprised of a planar mirror that has a reflecting surface orthogonal to the X axis and a planar mirror that has a reflecting surface orthogonal to the Y axis. In addition, the laser interferometer IF is comprised of two laser interferometers for the X axis that irradiate laser beams to the reference mirror RM along the X axis and a laser interferometer for the Y axis that irradiates a laser beam to the reference mirror RM along the Y axis, and the X coordinate and the Y coordinate of the stage 14 are measured by means of one laser interferometer IF for the X axis and one laser interferometer IF for the Y axis. A coordinate system (X, Y) comprising the X coordinate and the Y coordinate measured by the laser interferometers IF is referred to below as the stage coordinate system.

In addition, the angle of rotation θ about the Z axis of the stage 14 is measured by means of the difference in the measurement values of the two laser interferometers IF for the X axis. Information of the X coordinate, Y coordinate and angle of rotation θ measured by the laser interferometers IF is supplied to a coordinate measuring circuit 60 and a main control part 90, and the main control part 90 monitors the supplied coordinates while controlling the positioning operations of the stage 14 via a linear motor 18.

The alignment camera CA comprises a light source 62 that emits a broadband wavelength of, for example, a halogen lamp, and the illumination light that has been emitted from the light source 62 is irradiated to an alignment mark AM as a measurement point formed on the wafer SW via a collimator lens 63, a beam splitter 64 and an objective lens 61. The reflected light from the alignment mark AM is guided onto the index plate 66 via the objective lens 61, the beam splitter 64 and a condenser lens 65, and an image of the alignment mark AM is resolved on the index plate 66.

The light that has passed through the index plate 66 moves toward the beam splitter 68 via a first relay lens 67, and the light that has passed through the beam splitter 68 is focused onto the imaging plane of an X axis imaging apparatus CAX that uses, for example, a two-dimensional CCD, by means of an X axis relay lens 69X. In addition, the light that has been reflected by the beam splitter 68 is focused onto the imaging plane of a Y axis imaging apparatus CAY that uses, for example, a two-dimensional CCD, by means of a Y axis relay lens 69Y. The image of the alignment mark AM and the image of the index mark on the index plate 66 are resolved in a superposed manner onto the imaging planes of the X axis imaging apparatus CAX and the Y axis imaging apparatus CAY. The imaging signals of the imaging apparatuses CAX, CAY are both supplied to a coordinate measuring circuit 60.

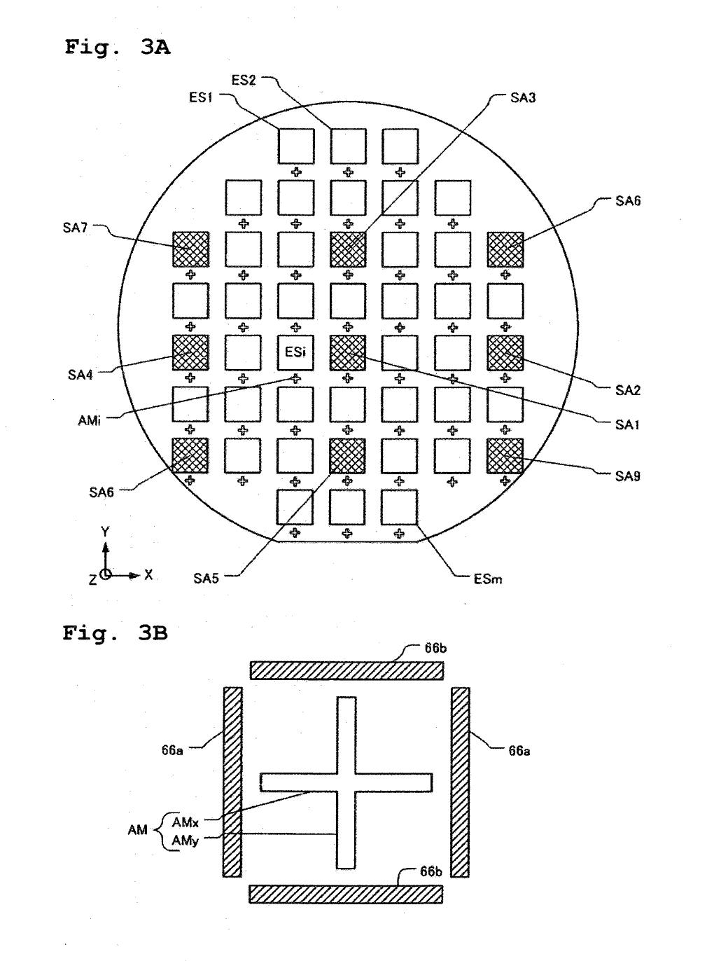

FIG. 3(a) is a drawing for describing an example of the alignment marks AM that are plurally formed on the wafer SW. In addition, in FIG. 3(b), a state in which an image of an alignment mark AM has been resolved on the index plate 66 is illustrated.

As shown in FIG. 3(a), chip regions ES1, ES2, ESm (m is an integer of 3 or higher) are formed on the wafer SW. In addition, the respective chip regions ESi are partitioned by scribe lines of a prescribed width that extend in the X axis directions and the Y axis directions, and alignment marks AMi for X axis and Y axis two-dimensional direction measurement are formed at the center parts of the scribe lines that come into contact with the respective chip regions ESi and extend in the X directions. Note that the chip regions (i=1∥m) shown in FIG. 3(a) are regularly aligned in squares, but, in actuality, chip regions ESi (i=1˜m) are enlarged and deformed into rhombus shapes or trapezoid shapes by such means as the heat treatment step (process) of the wafer SW, and the chip regions ESi (i=1˜m) of the entirety rotate and shift due to misalignment with respect to the coordinate system of the other apparatus.

The X coordinates (coordinate values in terms of design) Dxi and the Y coordinates (coordinate values in terms of design) Dyi of the alignment marks AMi on the wafer SW are already known and are stored in a storage part 92 within the main control part 19 of FIG. 2. In this case, the X coordinates and the Y coordinates of the alignment marks AMi are respectively considered to be the X coordinates and the Y coordinates of the respective chip regions ESi.

A prescribed number of chip regions among the plurality of chip regions ES1˜ESm that have been set on the wafer SW are selected in advance as sample chips (sample measurement points). In the example shown in FIG. 3(a), nine chip regions that have been marked with diagonal lines are selected as sample chips SA1˜SA9.

The alignment marks AM used in the first embodiment are cross shapes that comprise a linear pattern that extends in the X directions and a linear pattern that extends in the Y directions orthogonal thereto. When an image of this alignment mark AM is resolved on the index plate 66, the image shown in FIG. 3(b) is obtained. The image of the alignment mark AM comprises an image AMx that extends in the X directions and an image AMy that extends in the Y directions, and the X axis imaging apparatus CAX detects image AMy, and the Y axis imaging apparatus CAY detects image AMx.

The scanning direction when photoelectric conversion signals are read from the respective pixels of the X axis imaging apparatus CAX and the Y axis imaging apparatus CAY are respectively set in the X directions and the Y directions, and, by processing the imaging signals of the X axis imaging apparatus CAX and the Y axis imaging apparatus CAY, it is possible to obtain the amount of positional dislocation in the X axis directions of the alignment mark image AMy for the X axis and an index mark 66a and the amount of positional dislocation in the Y axis directions of the alignment mark AM for the Y axis and an index mark 66b. By using this alignment mark AM, it is possible to obtain position information in the X directions and position information in the Y directions with one measurement.

In addition, returning to FIG. 2, the coordinate measuring circuit 60, as a result of the positional relationship between the image AMy of the alignment mark AM and index mark 66a and the measurement results of the laser interferometer IF at that time, obtains the X coordinate of that alignment mark AM on the stage coordinate system (X, Y) and supplies the X coordinate measured in this way to the main control part 90. Similarly, the Y coordinate of the alignment mark for the Y axis on the stage coordinate system (X, Y) is measured and supplied to the main control part 90.

The main control part 90 performs an EGA operation based on the measurement results of the sample chips from the alignment camera CA and calculates the array of the chip regions ESi (i=1˜m) on the wafer SW. Here, an outline of the EGA operation performed by the main control part 90 is as follows.

The main control part 90 performs an EGA operation based on the respective measurement values and the respective design values of sample chips SA1-SA9. The EGA operation performed here takes into account six operation parameters comprising the residual rotational error Θ of the wafer SW, the orthogonality error Ω of the stage coordinate system (X, Y), the linear elongation and contraction (scaling) ┌x, ┌y of the wafer SW, and the offsets Ox, Oy of the wafer SW, which are factors that generate alignment error, and, when these are used, they are expressed by Equation (1) below. In addition, the X coordinate and the Y coordinate in terms of design of alignment mark AMn on the wafer SW are considered to be Dxn and Dyn respectively.

$$\begin{matrix}Equation 1 & \\ ( \begin{matrix}{Fx}_{n} \\ {Fy}_{n}\end{matrix} ) = ( \begin{matrix}1 + Γ x & - Ω - Θ \\ Θ & 1 + Γ y\end{matrix} ) ( \begin{matrix}{Dx}_{n} \\ {Dy}_{n}\end{matrix} ) + ( \begin{matrix}Ox \\ Oy\end{matrix} ) & ( 1 )\end{matrix}$$

The array coordinate values (Fxn, Fyn) in terms of calculation of the position to be actually aligned are calculated based on Equation (1) above, and, in the stage coordinate system (X, Y), the positions of the respective chip regions ESi on the wafer SW and elongation and contraction of the respective chip regions ESi are determined based on those calculated coordinate values.

Note that, in the first embodiment, the case in which nine sample chips SA1˜SA9 have been set on the wafer SW was described. However, the number of sample chips may be any number.

### Nanoimprint Method of the First Embodiment

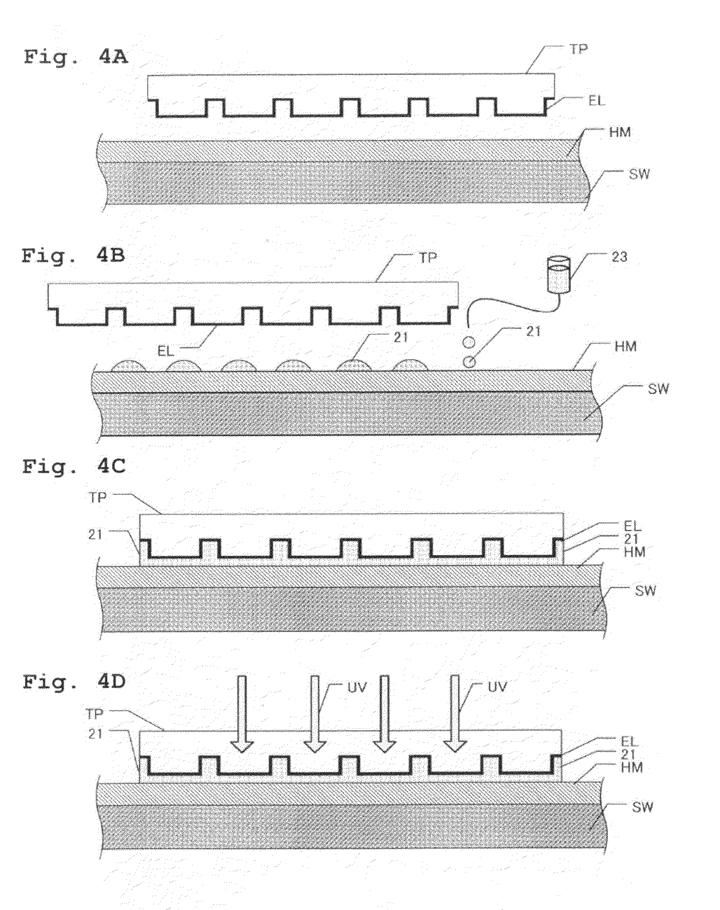

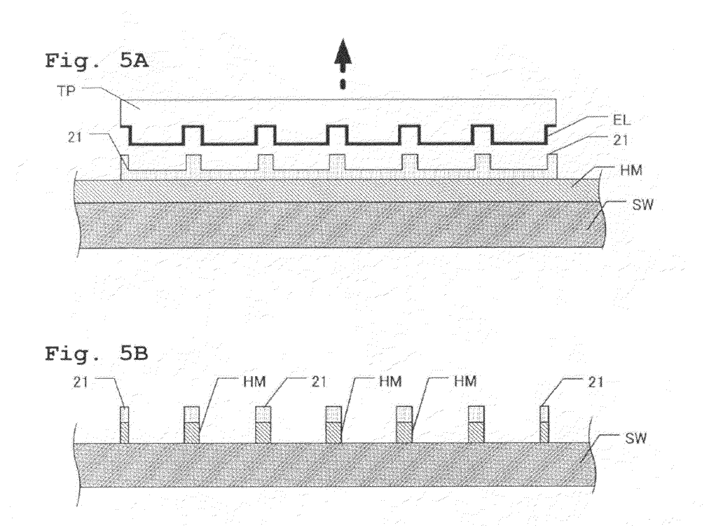

The nanoimprint method of the first embodiment will be described based on FIG. 4 and FIG. 5.

First, as shown in FIG. 4(A), the template TP, which has been provided with a peeling layer EL, and the wafer SW, which has been provided with a hard mask layer HM, are prepared. The template TP consists of, for example, quartz glass that allows ultraviolet light to pass through, and the peeling layer EL is provided in order to facilitate peeling of a resin to be discussed later, which has been cured by the ultraviolet light, and the template TP. In addition, a hard mask layer HM is provided in order to improve the etching chemical corrosion resistance at the time of etching of the wafer SW.

Next, as shown in FIG. 4(B), an ultraviolet ray curable liquid resin 21 for patterning is coated onto the wafer SW by means of a dispenser 23. An example of the ultraviolet ray curable resin 21 is an acrylic ultraviolet ray curable resin.

Next, as shown in FIG. 4(C), at least either one of the template TP and the wafer SW is subject to application of pressure with respect to the other so that pressure is applied to the UV curable liquid resin 21. When this is done, the UV curable liquid resin 21 in the gap between the template TP and the wafer SW conforms to the uneven pattern of the template TP. Note that alignment of the template TP and the wafer SW is performed by an EGA operation by the alignment camera discussed above.

In this state, as shown in FIG. 4(D), ultraviolet light UV is irradiated to the resin 21, and the UV curable resin 21 is UV cured. Through this, a thin resin 21 is formed on the hard mask layer HM of the wafer SW.

Next, as shown in FIG. 4(C), at least one of the template TP and the wafer SW is subject to application of pressure with respect to the other so that pressure is applied to the resin 21. When this is done, the resin 21 in the gap between the template TP and the wafer SW conforms to the uneven pattern of the template TP. Note that alignment of the template TP and the wafer SW is performed based on the results of the EGA operation that used the alignment camera CA discussed above.

In this state, ultraviolet light UV generated by an ultraviolet light source that is not shown and is provided within the holding part 50 is irradiated to the resin 21 as shown in FIG. 4(D) to cure the ultraviolet ray curable resin 21. Through this, a cured thin resin layer is formed on the hard mask layer HM of the wafer SW.

Next, as shown in FIG. 5(A), the template TP is peeled from the cured resin 21. The peeling layer EL makes peeling from the resin 21 easy. An uneven pattern comprising the cured resin 21 is formed on the hard mask layer HM of the wafer SW.

Next, as shown in FIG. 5(B), the cured resin 21 and the hard mask layer HM are etched, and the surface of the wafer SW is revealed. After that, a pattern in which the uneven pattern of the template TP has been inverted is formed on the wafer SW by etching the wafer SW.

### MODIFICATION EXAMPLE OF THE TEMPLATE TP

### Modification Example 1

### Modification Example of a Template TP Resulting From an Optical Fiber Bundle

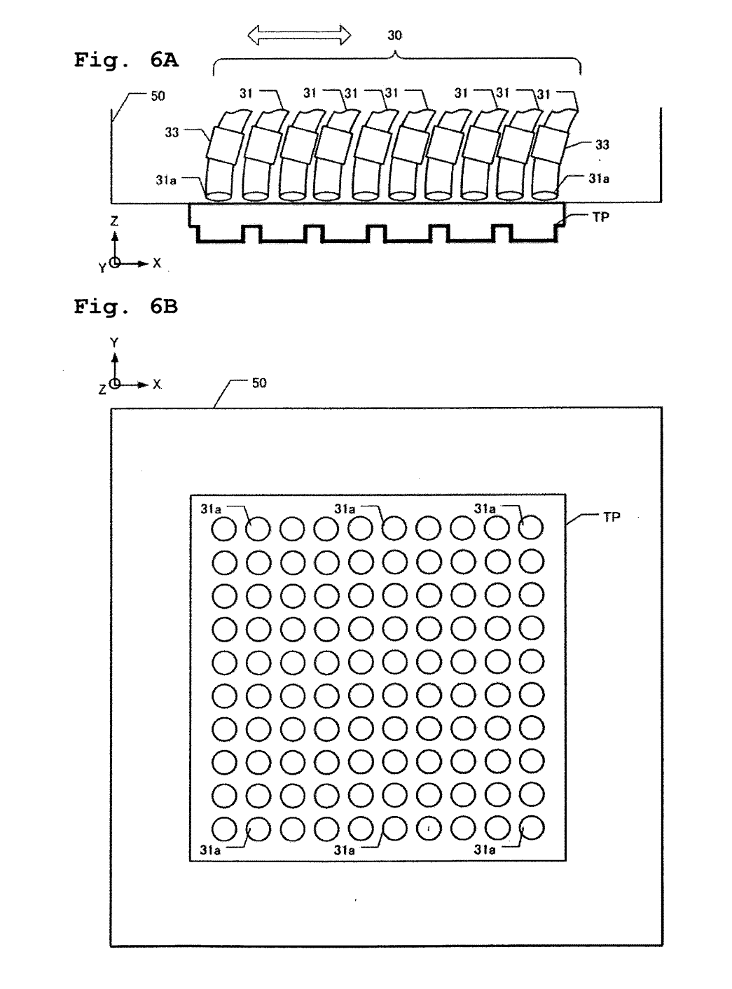

FIG. 6 is a drawing that depicts an optical fiber bundle 30 that is built into a holding part 50, which holds the template TP, along with the template TP, where FIG. 6(A) is a side surface schematic view, and FIG. 6(B) is an upper surface transparent schematic view.

The optical fiber bundle 30 is movably arranged within the holding part 50, and the optical fiber bundle 30 is arranged on the template TP as shown in FIGS. 6(A) and 6(B). The optical fiber bundle 30 comprises, for example, 10×10 optical fibers 31 for a total of 100, and one end 31a of those optical fibers 31 is arranged at a surface opposite to the uneven pattern of the template TP, and the other end is arranged at a heating light source that is not shown. The heating light source is, for example, a lamp that emits, for example, a large amount of infrared light. Switches 33 that turn the light from the heating light source on/off are arranged between this heating light source and one end 31a of the optical fibers 31. It is preferable that the optical fibers 31 be comprised of a material that includes germanium oxide, which has high infrared light transmittivity.

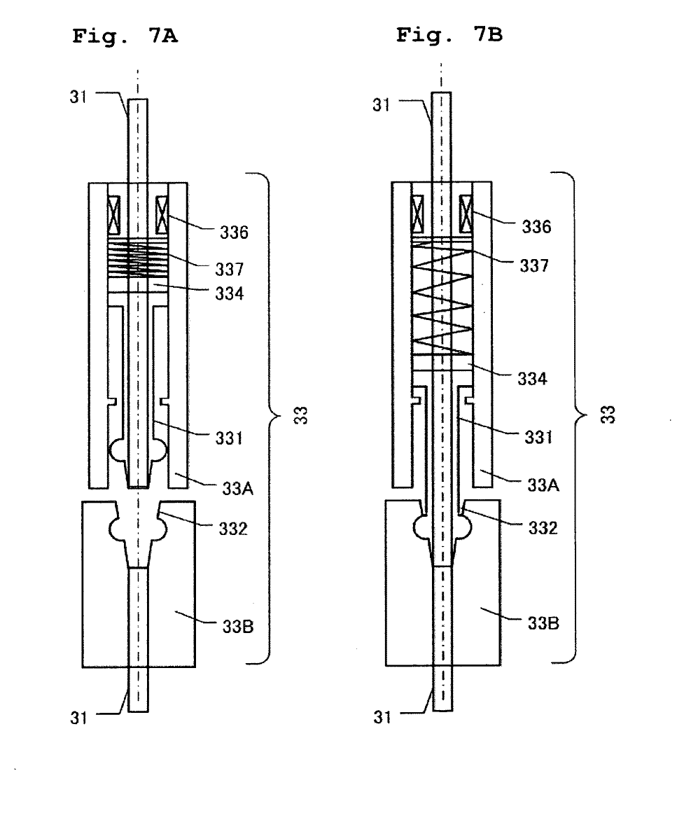

FIG. 7 shows the switch 33 of the optical fiber 31. FIG. 7(A) is an unconnected (off state) switch 33, and FIG. 7(B) is a connected (on state) switch 33.

The switch 33 of Modification Example 1 is comprised of a male switch 33A and a female switch 33B. The male switch 33A is a member with a hollow cylindrical shape. The optical fiber 31 is embedded in the center of an integrally formed magnet 334 and ferrule 331, and the end face thereof forms the same plane as the end face of the front end of the ferrule 331. In addition, the integrally formed magnet 334 and ferrule 331 are arranged coaxially within the male switch 33A. An electromagnet 336 is fixed to the male switch 33A. A spring 337 is installed between the electromagnet 336 and the magnet 334, and the ferrule 331 imparts energy in the front end direction.

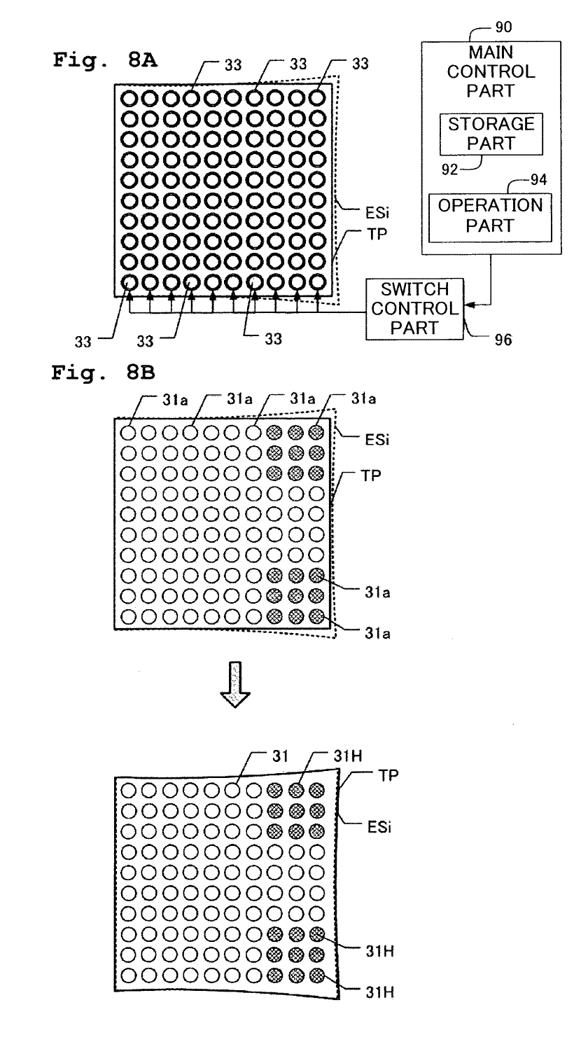

The electromagnet 336 is connected to a switch control part 96 shown in FIG. 8 via a wire. The off state shown in FIG. 7(A) shows a state in which an electric current is being supplied into the electromagnet 336 from the switch control part 96 and an electric field is generated, and the magnet 334 is attracted to overcome the resiliency of the spring 337 by means of attractive force, and, at this time, the ferrule 331 is pulled into the male switch 33A.

The female switch 33B is a cylindrical column-shaped member formed by a material that is able to elastically deform and in whose front end part a hole part for engagement has been formed. The optical fiber 31 is embedded in the center of the female switch 33B. The reason that the hole part for engagement, which is formed in the front end part of the female switch 33B, is formed is to have an engagement part 332 centering on the optical fiber 31. In addition, the end face of the optical fiber 31 forms the same plane as the bottom surface of the hole part for engagement.

In the case in which the male switch 33A and the female switch 33B are put into an engagement state, the electric current to the electromagnet 336 is blocked or the electric current in a direction which generates repulsive force between the electromagnet 336 and the magnet 334 is supplied to the electromagnet 336. Through this, by means of the resiliency of the spring 337, according to the sum of the repulsive force between the electromagnet 336 and the magnet 334 and the resiliency of the spring 337, the ferrule 331 jumps out from the male switch 33A and thrusts into the hole part for engagement formed in the female switch 33B, and the front end part of the ferrule 331 engages with the hole part for engagement of the female switch 33B. In this way, connection between the optical fibers 31 is completed.

From this state, in order to release the engagement state, an electric current is caused to flow into the electromagnet 336 in a direction in which an attractive force is produced between the electromagnet 336 and the magnet 334 by means of the switch control part 96 shown in FIG. 8. Through this, by means of the magnet 334 being attracted to the electromagnet 336 to overcome the resiliency of the spring 337, the engagement is released. Through this, the ferrule 331 returns to the male switch 33A, and the bonded state is released.

FIG. 8 is a schematic view that shows the procedure by which the optical fiber bundle 30 thermally deforms the template TP. FIG. 8(A) is an upper surface view that shows the template TP and control of the switches 33. The upper level of FIG. 8(B) is an upper surface view that shows the template TP and one end 31a of the optical fibers 31, and it shows a state prior to heating by the optical fibers 31, and the lower level shows the state after heating. In FIG. 8, the chip regions ESi shown by the dotted lines indicate deformed chip regions.

In FIG. 8(A), a switch control part 96 is connected to the respective switches 33. The switch control part 96 performs control that switches the switches 33 on/off. The main control part 90 is connected to the switch control part 96.

Provided at the main control part 90 is a storage part 92, which stores information (hereunder, referred to as heat deforming information) relating to the relationship between the amount of heating by the optical fibers 31 and the amount of deformation of the template TP. Included in the heat deforming information is, for example, the thermal expansion coefficient of the template TP, the heat increase rate of the template TP corresponding to the amount of heating by the optical fibers 31, etc. In addition, an operation part 94, which computes the amount of heat required for dimensional deformation of the template TP, is provided in the main control part 90.

The main control part 90 ascertains how the chip regions ESi are deforming based on the results of an EGA operation that uses the alignment camera CA and performs control that transfers the uneven pattern of the template TP to the wafer SW after deforming the template TP to correspond to the deformation states of these chip regions ESi.

The template TP is comprised of, for example, quartz glass, so, for example, the thermal expansion coefficient is 5 ppm/k (Kelvin). The template TP is heated and caused to conform to the shape of the chip regions ESi, so it is preferable that the uneven pattern of the template TP be manufactured in advance to be small from approximately 5 ppm to 40 ppm.

In FIG. 8(A), the chip regions ESi are such that the upper and lower corner parts of the right side extend further than the template TP. For this reason, the operation part 94 performs computation as to which switches 33 of the optical fiber 31 to set to the on state or as to how many seconds to set the switches to the on state. The result of this operation is sent to the switch control part 96, and the location and time of turning on the switches 33 is controlled.

As shown in FIG. 8(B), for example, light from the heating light source is caused to reach one end 31a (shown by the mesh) of 3×3, for a total of 9, optical fibers 31 of the upper right and one end 31a (shown by the mesh) of 3×3, for a total of 9, optical fibers 31 of the lower right, from among one end 31a of 10×10, for a total of 100, optical fibers 31 for a fixed period of time. When light is irradiated from the one end 31a of the optical fibers 31 for a fixed period of time, and heat is applied to the template TP, a part of the template TP thermally expands. Then, deformation to a template TP equivalent to the chip regions ESi is performed as shown in the lower level of FIG. 8(B). After that, if the template is pressed to a semiconductor wafer, it is possible to form a pattern by superposing to the already formed chip regions ESi.

### Modification Example 2

### Modification Example of the Template TP Resulting From A Spatial Light Modulation Part

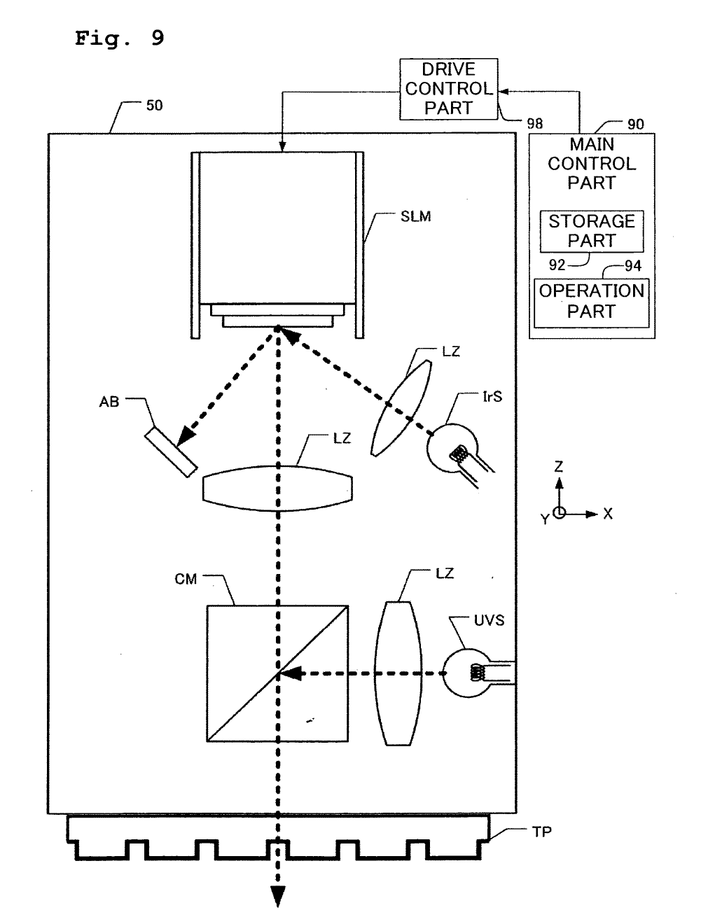

FIG. 9 is a side surface schematic view that depicts the spatial light modulation part SLM that is built into the holding part 50, which holds the template TP, as well as the template TP.

The spatial light modulation part SLM is arranged within the holding part 50. The light reflecting surface of the spatial light modulation part SLM comprises, for example, 16,384 micro mirrors arrayed in a 128×128 matrix shape. The respective micro mirrors are able to rotate and tilt centering on a diagonal line by means of voltage from a drive control part 98. An infrared light lamp IrS, which is the heating light source, irradiates infrared light to the spatial light modulation part SLM via an optical lens LZ. The infrared light reflected by the spatial light modulation part SLM is guided to a dichroic prism CM.

On the other hand, an ultraviolet light source UVS that generates ultraviolet light is arranged inside the holding part 50. The ultraviolet light generated from the ultraviolet light source UVS is guided to the dichroic prism CM via an optical lens LZ. The dichroic prism CM allows the infrared light to pass through to the template TP side and reflects the ultraviolet light to the template TP side.

When tilting of any micro mirror of the spatial light modulation part SLM shown in FIG. 9 by a prescribed angle is performed, the infrared light that is incident thereto moves toward the dichroic prism CM and is reflected. When the attitude of the micro mirror is set to an angle that is different from the prescribed angle thereof, the infrared light moves toward a light absorbing plate AB and is reflected.

A storage part 92, which stores heat deforming information, is provided in the main control part 90 as discussed above. In addition, an operation part 94, which computes the amount of heat required for dimensional deformation of the template TP, is provided in the main control part 90.

The operation part 94 performs computation as to which micro mirrors to tilt by a prescribed angle or as to how many seconds to tilt the micro mirrors by a prescribed angle to conform to the deformation states of the chip regions ESi. The result of this operation is sent to the drive control part 98, and the drive control part 98 controls the attitudes of the respective micro mirrors based on the result of that operation. After the template TP has been deformed to correspond to the shapes of the chip regions ESi, if the template TP is pressed to the wafer SW, it is possible to form a pattern superposed with the chip regions ESi that have already been formed. While in that state, if ultraviolet light is irradiated from the ultraviolet light source UVS, it is possible to cure the resin 21.

Operations from EGA Measurement of the Wafer SW Up Until Curing of the UV Curable Resin

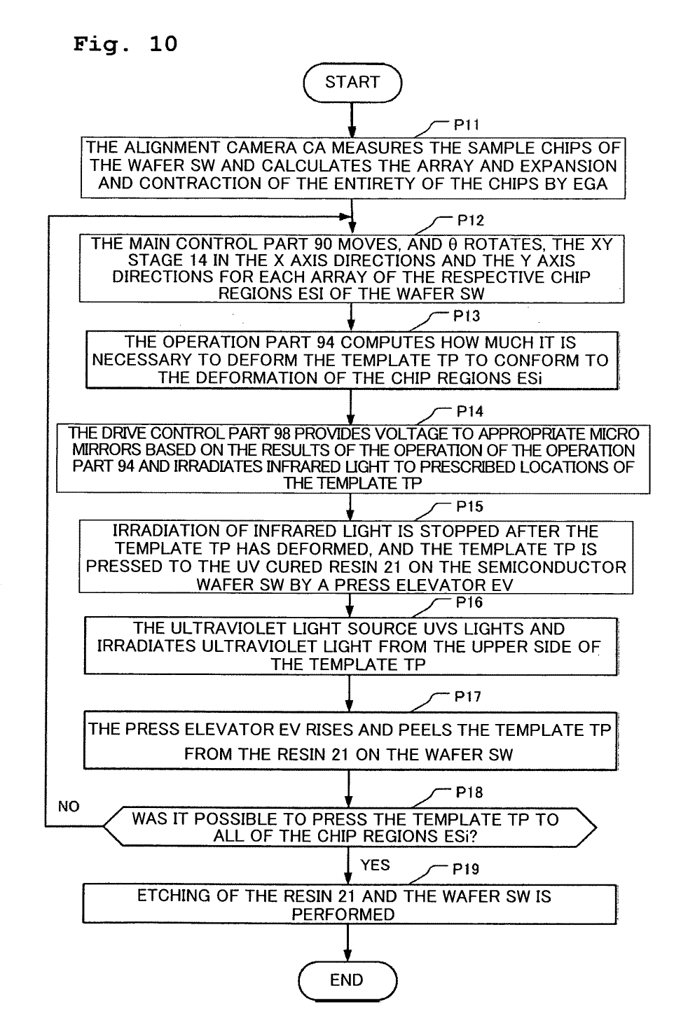

FIG. 10 is a flow chart that shows the procedure from EGA measurement of the alignment marks AM of the wafer SW up to curing of the UV curable resin 21. Note that, in the steps to be described below, the overall configuration is as described in FIG. 1, and the EGA operation uses a method such as that described in FIG. 2 and FIG. 3. In addition, deformation of the template TP uses the spatial light modulation part SLM described in Modification Example 2.

In step P11, the alignment camera CA measures sample chips SA1˜SA9 of the wafer SW and calculates the overall array of chip regions ES1˜ESm based on the EGA operation discussed above.

In step P12, the main control part 90 moves the stage 14 in the X axis directions and the Y axis directions for each array of the respective chip regions ESi of the wafer SW and rotates the stage 14 about the Z axis. Through this, alignment of the template TP and the chip regions ESi is possible. However, in this step, superposing to the extent of the difference in size between the template TP and the chip regions ESi is not accomplished.

In step P13, the operation part 94 computes to what extent it is necessary to deform the template TP to conform to the deformation of the chip regions ESi.

In step P14, the drive control part 98 provides voltage to appropriate micro mirrors of the spatial light modulation part SLM based on the result of the operation of the operation part 94 and irradiates infrared light to prescribed locations of the template TP.

Note that, instead of the spatial light modulation part SLM, which is a reflecting element, a transmitting type spatial modulation element, which changes the transmittivity using liquid crystals, may also be used.

In step P15, the template TP deforms by means of thermal expansion to correspond to the irradiation amount of infrared rays. Then, the drive control part 98 stops irradiation of infrared light. After that, the main control part 90 presses the template TP to the resin 21 on the wafer SW by means of the press elevator EV.

In step P16, the ultraviolet light source UVS lights, and ultraviolet light is irradiated to the resin 21 from the upper side of the template TP. Note that the dichroic prism CM is able to synthesize the light beam of the infrared light and the light beam of the ultraviolet light as shown in FIG. 9, so it is not necessary to move one of the light sources, etc. even when switching of irradiating of infrared light and irradiating of ultraviolet light is performed.

In step P17, the main control part 90 raises the press elevator EV and peels the template TP from the cured resin 21.

In step P18, the main control part 90 makes a determination as to whether or not the template TP could be pressed to all of the chip regions ESi. In addition, if the template TP is not being pressed to the resin 21 on all of the chip regions ESi, step P12 is proceeded to. If the template TP is being pressed to the resin 21 on all of the chip regions ESi, step P19 is proceeded to. If infrared light is not being irradiated, the template TP is naturally cooled by the air in the vicinity and returns to its original size. In order to increase throughput, instead of natural cooling, compressed air may also be sprayed out to the template TP using a nozzle, etc.

In step P19, etching of the cured resin 21 and the wafer SW is performed.

Note that, in the first embodiment, heat of infrared light was used to deform the template TP, but it is also possible to two-dimensionally dispose fine nozzles and blow air that has a high temperature. In addition, deformation of the template TP is such that deformation may be performed not only by heat but by pressure application from the side surface of the template TP.

In addition, in the first embodiment, a description was given using an ultraviolet ray curable resin as the curable resin, but a heat curable resin may also be used. If this heat curable resin is used, in a state in which the template TP has been pressed to the resin 21 on the wafer SW, for example, infrared light is irradiated from the optical fiber bundle 30 or infrared light is irradiated using all of the micro mirrors of the spatial light modulation part SLM.

### Nanoimprint Methods of the Second and Third Embodiments

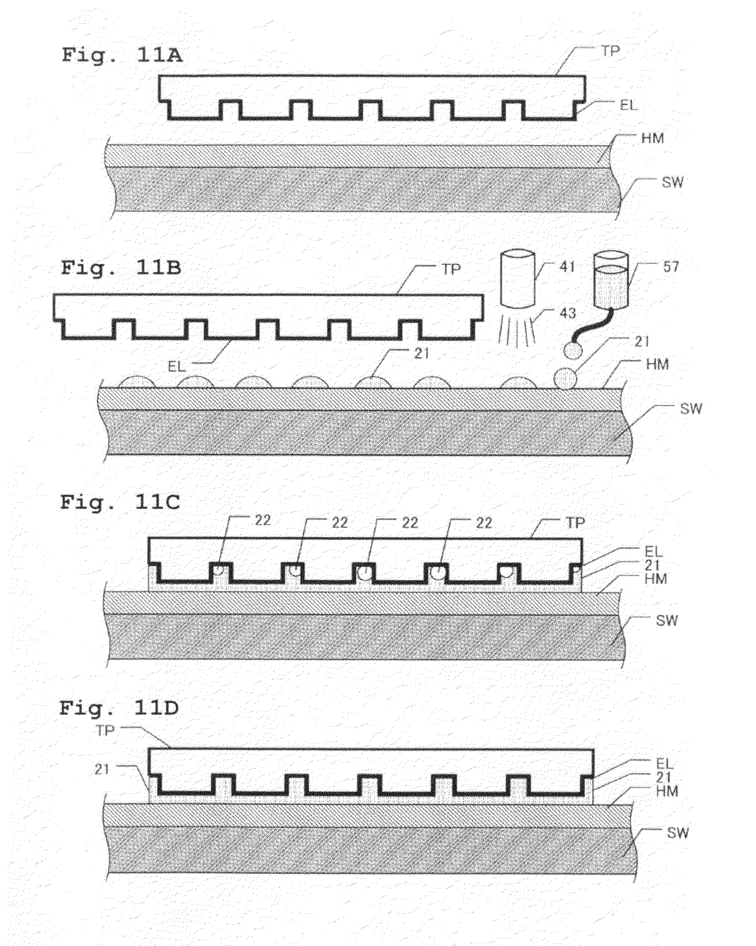

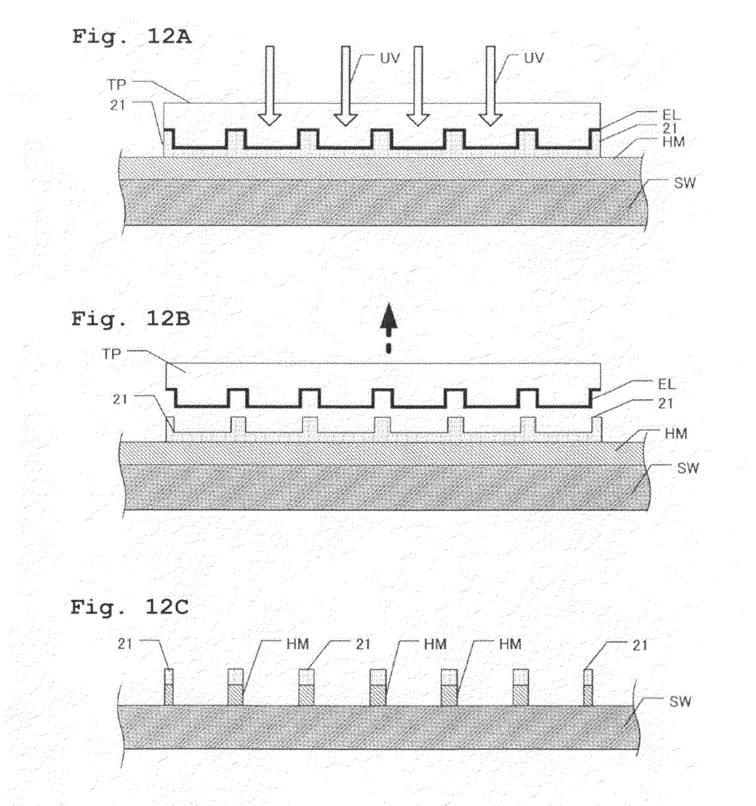

An outline of the nanoimprint methods of the second embodiment and the third embodiment will be described based on FIG. 11 and FIG. 12.

First, as shown in FIG. 11(A), the template TP, which has been provided with a peeling layer EL, and the wafer SW, which has been provided with a hard mask layer HM, are prepared. The template TP consists of, for example, quartz glass that allows ultraviolet light to pass through, and the peeling layer EL is provided in order to facilitate peeling of a resin to be discussed later, which has been cured by the ultraviolet light, and the template TP. In addition, a hard mask layer HM is provided in order to improve the etching chemical corrosion resistance at the time of etching of wafer SW. An uneven pattern on the nano order is formed on the lower surface of the template TP.

Next, as shown in FIG. 11(B), an ultraviolet ray curable liquid resin 21 for patterning is coated onto the wafer SW by means of a dispenser 57. An example of the ultraviolet ray curable resin 21 is an aliphatic group allyl urethane, a nonvolatile material, an aromatic methacrylate, an aromatic acrylic ester, an acrylated polyester oligomer, an acrylate monomer, a polyethylene glycol dimethacrylate, a lauryl methacrylate, an aliphatic diacrylate, a trifunctional acid ester or an epoxy resin. In addition, the molecular weights of these are within a range of a weight average molecular weight of 100˜10,000.

A gas supply part 41 supplies a gas 43 to the resin 21 that has been coated onto the hard mask layer HM of the wafer SW. This gas 43 is a gas that dissolves easily in resin. The atmosphere of the vicinity of the resin 21 is substituted with the gas 43.

Next, as shown in FIG. 11(C), at least either one of the template TP and the wafer SW is subject to application of pressure with respect to the other so that pressure is applied to the resin 21. When this is done, the resin 21 in the gap between the template TP and the wafer SW is inserted into the nano order uneven pattern of the template TP. First, since the gas 43 is present in the nano order uneven pattern, gas bubbles 22 are present between the template TP and the wafer SW, that is, in the liquid resin 21.

However, the gas bubbles 22 gradually dissolve in the resin 21 and, if they are small gas bubbles 22, dissolve in the resin 21 within several seconds. A state in which all of the gas bubbles 22 have disappeared is the state shown in FIG. 11(D). The main constituent of these gas bubbles 22 is not air (oxygen and nitrogen), which is the external atmosphere; the gas 43 that dissolves easily in the resin 21 is the main constituent.

In a state in which all of the gas bubbles 22 have been eliminated, as shown in FIG. 12(A), ultraviolet light UV is irradiated to the resin 21 to cure the ultraviolet ray curable resin 21. Through this, a cured thin resin layer is formed on the hard mask layer HM of the wafer SW. For example, the liquid resin 21 is cured by applying ultraviolet light of a broad spectrum that supplies power of 10˜10,000 mJ/cm² for approximately 10˜20 seconds.

As shown in FIG. 12(B), the template TP is peeled from the cured resin 21. The peeling layer EL peels easily from the resin 21. An uneven pattern comprising the cured resin 21 is formed on the hard mask layer HM of the wafer SW. The uneven pattern formed on this resin 21 is such that the uneven state is inverted with respect to the uneven pattern of the template TP.

Next, as shown in FIG. 12(C), the cured resin 21 and a hard mask layer HM are etched, and the surface of the wafer SW appears. After that, the inverted uneven pattern is formed on the wafer SW by etching the wafer SW.

### Second Embodiment

### Second Nanoimprint Apparatus 200

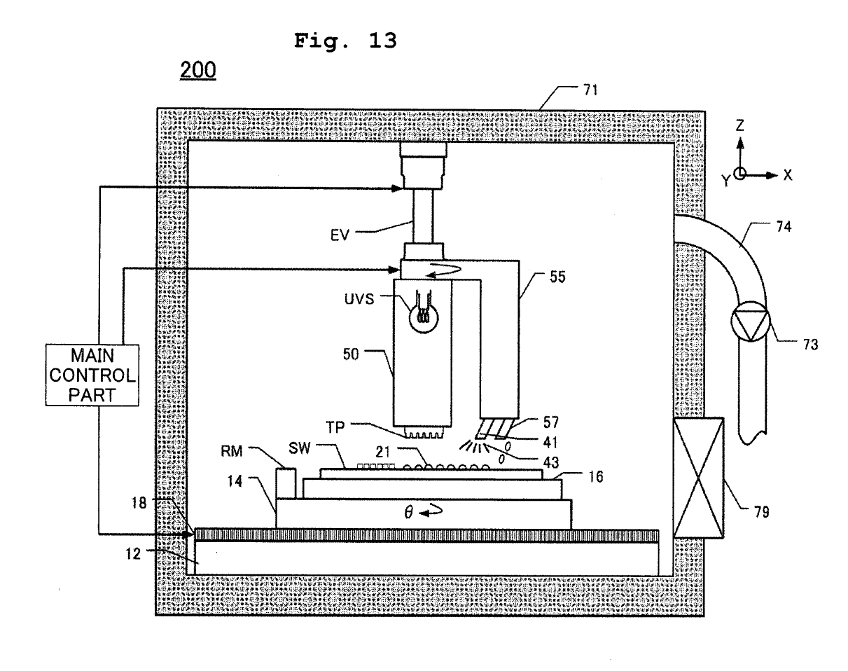

FIG. 13 is a schematic view that shows a second nanoimprint apparatus 200. The second nanoimprint apparatus 200 transfers an uneven pattern of a template TP to a wafer SW. As shown in FIG. 13, the template TP and the wafer SW are stored within a chamber 71.

The second nanoimprint apparatus 200 has a holding part 50, which holds the template TP. An ultraviolet light source UVS for curing the resin 21 is provided in the holding part 50. A transmission member or an opening is provided at the location where the holding part 50 and the template TP come into contact so that ultraviolet light from the ultraviolet light source UVS is irradiated.

The holding part 50 is supported by a press elevator EV, and this press elevator EV is attached to the ceiling of the chamber 71 of the second nanoimprint apparatus 200. The press elevator EV is able to move the template TP in the Z axis directions (vertical directions). The press elevator EV causes the template TP and the wafer SW to approach each other and is able to transfer an uneven pattern to the resin 21 that has been formed on the wafer SW.

A rotating arm 55 is arranged between the holding part 50 and the press elevator EV. The rotating arm 55 is able to rotate 360° centering on the Z axis by means of a motor, etc. while being able to move in the Z axis directions (vertical directions) by means of the press elevator EV. A dispenser 57, which coats the resin 21, is arranged at the front end of the rotating arm 55. In addition, a gas supply part 41, which supplies a gas 43 so as to cover the periphery of the coated resin 21 with the gas 43 is arranged at the front end of the rotating arm. This gas supply part 41 is arranged between the dispenser 57 and the template TP along the XY plane, and the dispenser 57, the gas supply part 41 and the template TP are arranged at fixed intervals along the XY plane. In addition, the rotating arm 55 moves in the Z axis directions by means of the press elevator EV, so it is held at a fixed distance with respect to the heights of the dispenser 57 and the gas supply part 41 in the Z axis directions and the height of the template TP. Note that the pipe that supplies the resin 21 to the dispenser 57 and the pipe that supplies the gas 43 to the gas supply part 41 are not shown.

On the other hand, the wafer SW is fixed by vacuum chucking or electrostatic chucking by means of a chucking table 16. This chucking table 16 is supported on a stage 14. The stage 14 is able to move in the X axis directions and the Y axis directions and is also able to rotate centering on the Z axis. The stage 14 is such that, movement is possible at a maximum stroke of, for example, approximately 200 mm in the X axis and Y axis directions. A reference mirror RM that extends in the X axis directions and the Y axis directions is fixed to the end part of the stage 14.

A laser interferometer (not shown) is comprised of two laser interferometers for the X axis that irradiate laser beams to the reference mirror RM along the X axis and a laser interferometer for the Y axis that irradiates a laser beam to the reference mirror RM along the Y axis, and the X coordinate and the Y coordinate of the stage 14 are measured. The rotation angle θ of the stage 14 is measured by means of the difference in the measurement of values of the two laser interferometers for the X axis. The information of the X coordinate, the Y coordinate and the rotation angle θ measured by the laser interferometers is supplied to a main control part 90, and the main control part 90 monitors the supplied coordinates while controlling the positioning operation of the stage 14 via a linear motor 18.

The linear motor 18 is provided on the stage 14, and the linear motor 18 drives the stage 14 in the X axis and Y axis directions and in the θ directions centering on the Z axis. In addition, the stage 14 is mounted on a vibration isolating table 12 so as not to be subject to the effects of external vibration.

Note that, in FIG. 13, the configuration is such that the template TP moves vertically by means of the press elevator EV, and the wafer SW is mounted on the stage 14 and moves in the X axis and Y axis directions, but the configuration may also be such that the template TP moves in the X axis and Y axis directions, and the wafer SW moves vertically by means of a press elevator.

The chamber 71 of the second nanoimprint apparatus 200 has an exhaust pipe 74 at a part thereof, and a pressure reduction pump 73 is connected to that exhaust pipe 74. The interior of the chamber 71 is in a state in which the pressure has been reduced to below atmospheric pressure. In addition, the chamber 71 has a load lock gate 79, and the wafer SW can be loaded into the second nanoimprint apparatus 200 and unloaded to outside the second nanoimprint apparatus 200. Note that the interior of the chamber 71 need not be made a high vacuum.

The main control part 90 controls driving of the respective parts of the second nanoimprint apparatus 200. Specifically, the main control part 90 is connected to, for example, the press elevator EV, the rotating arm 55 and the linear motor 18 and controls the driving of these. In addition, the main control part 90, for example, drives the gas supply part 41 and the dispenser 57 and lights the ultraviolet light source UVS.

Operation of the Second Nanoimprint Apparatus 200

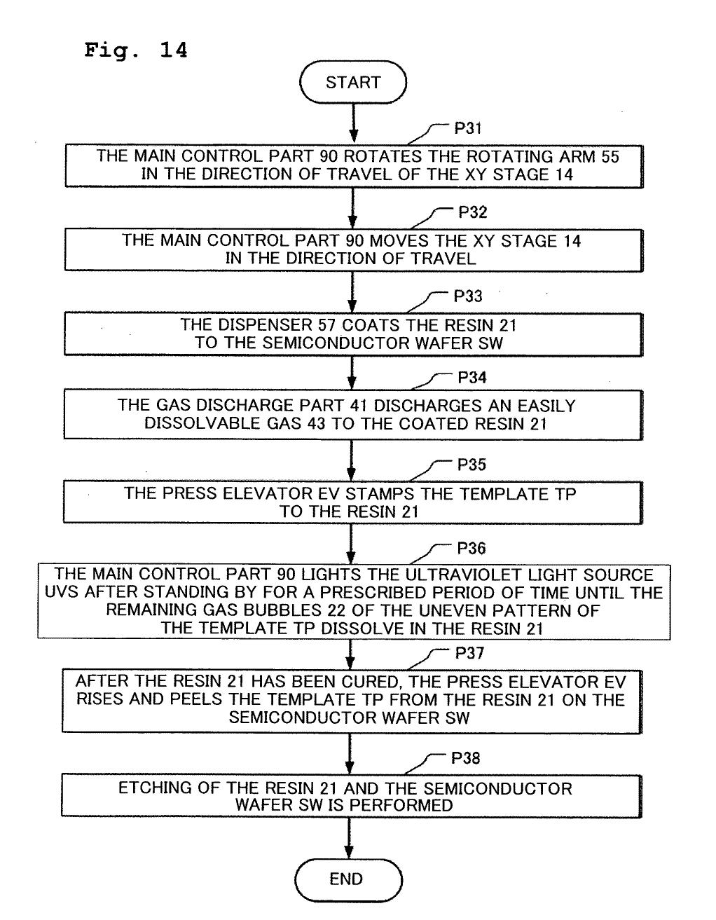

FIG. 14 is a flow chart that shows the procedure by which an inverted pattern of the uneven pattern of the template TP is formed on the wafer SW by means of the second nanoimprint apparatus 200 shown in FIG. 13. Note that, in the steps to be described below, the overall configuration is as described in FIG. 13, and the state of the resin 21 is as described in FIG. 11 and FIG. 12.

In step P31, the main control part 90 rotates the rotating arm 55 to conform to the sequence in which the template TP is pressed, that is, to match the direction of travel of the stage 14.

In step P32, the main control part 90 moves the stage 14 in the X axis directions and the Y axis directions to match the sequence in which the template TP is pressed.

In step P33, the main control part 90 causes the dispenser 57 to coat the resin 21 to the wafer SW. The resin 21 is directly supplied from within a tank that does not come into contact with the air (oxygen and nitrogen).

In step P34, the main control part 90 causes the gas 43, which dissolves easily in the coated resin 21, to be supplied by the gas supply part 41. After the resin 21 has been coated to the wafer SW, the vicinity of the resin 21 is covered with the gas 43 as quickly as possible.

In step P35, the main control part 90 causes the press elevator EV to stamp the template TP to the resin 21 on the wafer SW.

In step P36, the main control part 90 lights the ultraviolet light source UVS after a prescribed period of time has elapsed up until the gas bubbles 22 remaining in the uneven pattern of the template TP dissolve in the resin 21. The vicinity of the resin 21 is covered with the gas 43, so the gas bubbles 22 that remain in the uneven pattern dissolve within the resin 21 quickly in comparison with the gas bubbles resulting from air.

In step P37, after the resin 21 has cured, the main control part 90 raises the press elevator EV and peels the template TP from the cured resin 21.

In step P38, etching of the cured resin 21 and the wafer SW is performed.

### Modification Example 3

### Arrangement of the Gas Supply Part 41 and the Dispenser 57

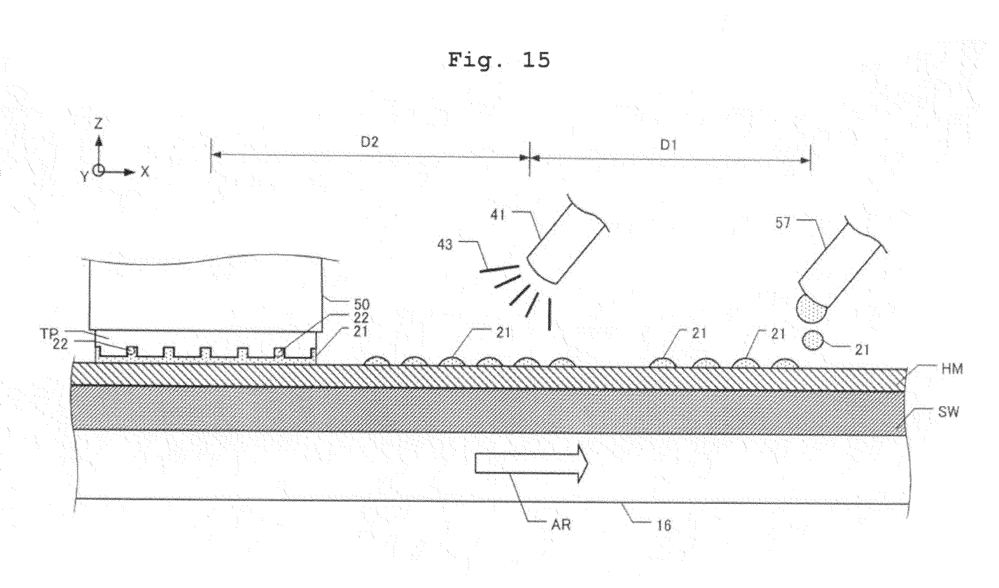

FIG. 15 is an enlarged schematic view of the vicinity of the gas supply part 41, the dispenser 57 and the template TP. In addition, FIG. 15 shows a state in which a chucking table 16 is moving in the X axis directions shown by arrow AR. The chucking table 16 is moving in the X axis directions, so the rotating arm 55 shown in FIG. 13 rotates in the X axis directions, which is the direction of travel, and the dispenser 57 and the gas supply part 41 are arranged in the direction of travel of the template TP.

As shown at the right side of FIG. 15, the dispenser 57 coats the resin 21 to the hard mask layer HM of the wafer SW immediately prior to pressing the resin 21 using the template TP. This is to shorten the time that the resin 21 comes into contact with the air (oxygen and nitrogen) within the chamber 71. In addition, it is preferable that the resin 21 be stored within a tank in a reduced pressure state and that there be as little as possible gas that the resin 21 dissolves.

The resin 21 that has been coated by the dispenser 57 is such that the vicinity thereof is covered with a gas 43 supplied from the gas supply part 41. Specifically, the vicinity of the coated resin 21 is substituted from air (oxygen and nitrogen) to the gas 43. The gas 43 is such that, for example, if the molecular weight is small, the rates of dissolution in the resin 21 will improve, and a gas that has a molecular weight lower than that of air (oxygen and nitrogen), such as helium (He) and hydrogen (H2) would be preferable. In the case in which an acrylic resin is used as the resin 21, carbon dioxide (CO₂) or ammonia gas (NH₃) dissolve easily, so it is preferable that carbon dioxide (CO₂) or ammonia gas (NH₃) be used as the gas 43.

In addition, the supplied gas 43 may also be, for example, a vapor of a solvent of the resin 21. Examples of typical solvents that can be used are toluene, dimethyl formamide, chlorobenzene, xylene, dimethyl sulfoxide (DMSO), dimethyl formamide, dimethyl acetoamide, dioxane, tetrahydrofuran (THF), methylene chloride, ethylene chloride, carbon tetrachloride, chloroform, lower alkyl ether, hexane, cyclohexane, benzene, acetone and ethyl acetate.

The resin 21 is coated, and the chucking table 16 moves to a region in which the gas 43 is supplied to the periphery thereof. Making the distance D1 between the dispenser 57 and the gas supply part 41 and the distance D2 between the gas supply part 41 and the template TP, which are shown in FIG. 15, as short as possible makes it easier for the air (oxygen and nitrogen) of the vicinity of the resin 21 to be substituted with the gas 43. The template TP is stamped to the resin 21 after the air of the vicinity of the resin 21 has been substituted with the gas 43. Air bubbles 22 are produced when the resin 21 is inserted into the uneven pattern of the template TP, but these air bubbles 22 are formed by the gas 43, which dissolves easily in the resin 21. Therefore, if the time during which gas bubbles of air (oxygen and nitrogen) of a certain diameter dissolve in the resin 21 is approximately, for example, 10 seconds, gas bubbles 22 of the same diameter comprised of the gas 43 will dissolve in the resin 21 within several seconds. For this reason, in addition to the time required for dissolution of the gas bubbles formed within the uneven pattern of the template TP being shortened, shortening of the time required for forming an uneven pattern on the wafer SW by means of the resin 21 can be achieved.

### Modification Example 4

### Arrangement of the Gas Supply Parts 41 and the Dispensers 57

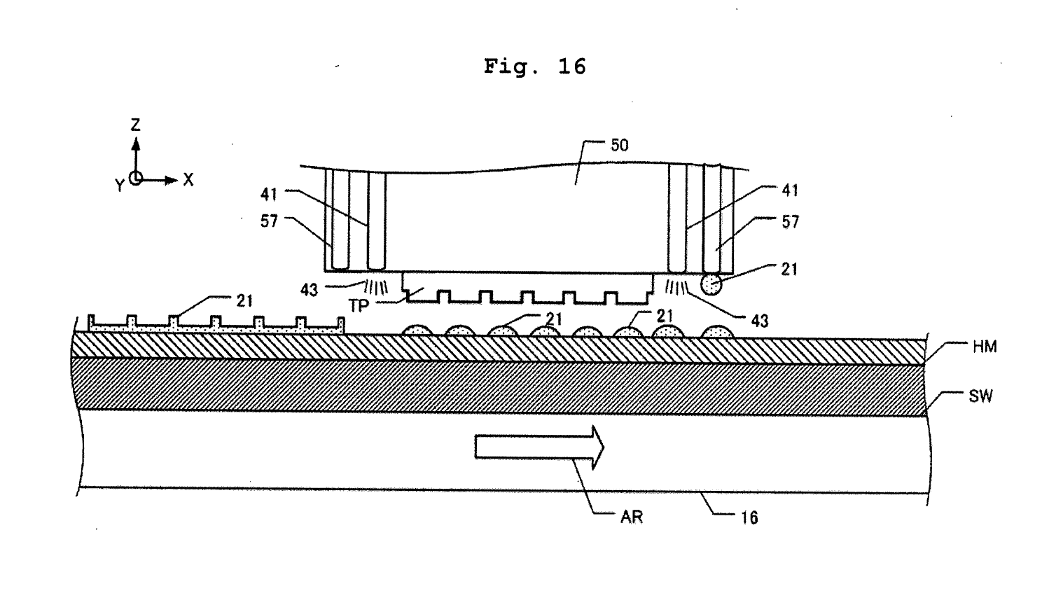

FIG. 16 is a separate embodiment from FIG. 15 and is an enlarged schematic view of the vicinity of the gas supply parts 41, the dispensers 57 and the template TP. In FIG. 16 as well, the chucking table 16 moves in the X axis directions shown by arrow AR. In FIG. 16, the gas supply parts 41 and the dispensers 57 are arranged in a holding part 50. The gas supply parts 41 and the dispensers 57 are arranged in the vicinity of the template TP and along the four sides of the holding part 50. In FIG. 16, only the gas supply parts 41 and the dispensers 57 that are arranged at the two sides in the X axis directions are depicted.

The dispensers 57 coat the resin 21 to the hard mask layer HM of the wafer SW immediately prior to the resin 21 being pressed by the template TP. The chucking table 16 moves in the X axis directions shown by arrow AR, so only the dispensers 57 in the direction of travel coat the resin 21 to the hard mask layer HM of the wafer SW. On the other hand, the gas supply parts 41 arranged at the four sides supply gas toward the resin 21 from four directions. Through this, the atmosphere in the vicinity of the template TP is substituted from air (oxygen and nitrogen) to a gas 43 that dissolves easily in resin.

The dispensers 57 and the gas supply parts 41 shown in FIG. 16 can be arranged near the template TP. For this reason, it is possible to shorten the time for the resin 21 to come in contact with the air (oxygen and nitrogen) within the chamber 71, and it is possible to easily substitute the vicinity of the template TP with the gas 43 that dissolves easily in resin.

### Third Embodiment

### Third Nanoimprint Apparatus 250

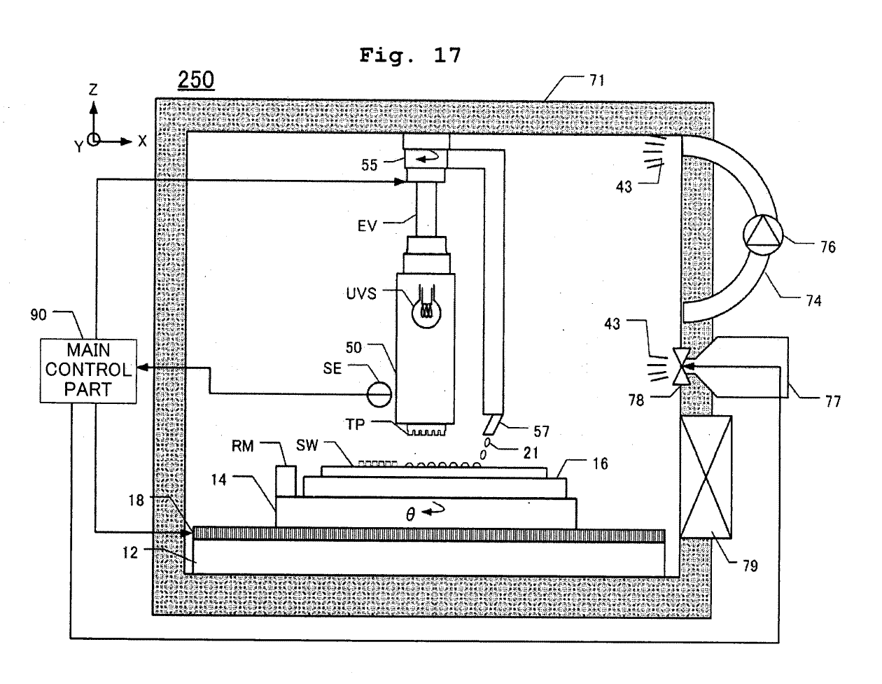

FIG. 17 is a schematic view that shows a third nanoimprint apparatus 250. The third nanoimprint apparatus 250 transfers an uneven pattern of the template TP to the wafer SW. The second nanoimprint apparatus 200 of the first embodiment comprised a gas supply part 41, and that gas supply part 41 substituted the atmosphere of the vicinity of the template TP from air (oxygen and nitrogen) to a gas that dissolves easily in the resin 21. The third nanoimprint apparatus 250 is such that it fills the entirety of the interior of a chamber 71 with a gas that dissolves easily in a resin 21. Hereunder, the third nanoimprint apparatus 250 will be described while emphasizing the aspects that are different from the second nanoimprint apparatus 200 described in FIG. 13. Note that, identical symbols are assigned to identical functional components.

A rotating arm 55 is arranged between a holding part 50 and a press elevator EV. A dispenser 57, which coats the resin 21, is arranged at the front end of this rotating arm 55.

A chamber 71 of the third nanoimprint apparatus 250 has an exhaust pipe 74 at a part thereof, and a circulation pump 76 is connected to that exhaust pipe 74. In addition, a gas tank 77, which has stored a gas 43 that dissolves easily in the resin 21, is connected to the chamber 71. A valved 78, which regulates the gas flow rate, is connected to the gas tank 77. In addition, the chamber 71 has a load lock gate 79, and a wafer SW can be loaded into the third nanoimprint apparatus 250 and unloaded to outside the third nanoimprint apparatus 250. In addition, a sensor SE, which detects the gas concentration, is arranged in the holding part 50.

The interior of the chamber 71 is filled with the gas 43. The circulation pump 76 circulates the gas 43 using the exhaust pipe 74 so that the gas density of the chamber 71 becomes uniform. The sensor SE measures the concentration of the gas 43 of the atmosphere of the vicinity of the template TP, and the results thereof are sent to a main control part 90, so the main control part 90 opens and closes the valved 78 if the concentration of the gas 43 has become lower than the prescribed concentration. When this is done, the valved 78 opens, and a gas that dissolves easily in resin is released from the gas tank 77.

In addition, in the second embodiment and the third embodiment, a description was given in which an ultraviolet ray curable resin was used as the curable resin, but it is also possible to use a heat curable resin instead of the ultraviolet ray curable resin. In the case in which a heat curable resin is used, it is preferable that a gas that dissolves easily in heat curable resin be supplied instead of the gas 43.

### REFERENCE SIGNS LIST

resin
gas bubbles
optical fiber bundle (31 optical fiber)
switch (33A male switch, 33B female switch)
331 ferrule
334 magnet
336 electromagnet
41 gas supply part
43 gas
50 holding part
55 rotating arm
71 chamber
73 depressurizing pump
74 exhaust pipe
76 vacuum pump
77 gas tank
78 valve
79 load lock gate
90 main control part
92 storage part
94 operation part
96 switch control part
98 drive control part
100, 200, 250 nanoimprint apparatus
AM alignment mark
CA alignment camera
CM dichroic prism
EV press elevator
IrS infrared light lamp
LZ optical lens
SW wafer
TP template
UVS ultraviolet light source

1. A nanoimprint method for pressing a template, on which a pattern with an uneven shape is formed, to a substrate coated with a curable resin, the method comprising:
a measuring step for measuring positions of a prescribed number of sample measurement points selected in advance from among measurement points set in regions to be processed of the substrate, respectively;
a calculating step for performing statistical operations with the measurement positions of the sample measurement points as operation parameters and calculating deformation states of the regions to be processed;
a deforming step for deforming the template based on the deformation states of the regions to be processed calculated in the calculating step; and
a pressing step for pressing the deformed template to the regions to be processed.

2. The nanoimprint method according to claim 1, wherein the deformation states calculated in the calculating step include at least one of offset, rotation and orthogonality; and
the method further comprises an alignment step for performing alignment of the template and the substrate based on the at least one of the offset, the rotation and the orthogonality.

3. The nanoimprint method according to claim 1, wherein the deforming step deforms the template by heating.

4. The nanoimprint method according to claim 1, wherein the deforming step deforms the template by pressure application.

5. A nanoimprint method for pressing a template, on which a pattern with an uneven shape is formed on a first surface of the template, to a substrate coated with a curable resin, the method comprising:
a heat deforming step for thermally deforming the template so as to conform to regions to be processed of the substrate; and
a pressing step for pressing the thermally deformed template and the regions to be processed with each other.

6. The nanoimprint method according to claim 5, wherein the heat deforming step heats prescribed regions of a second surface which is opposite to the first surface.

7. The nanoimprint method according to claim 6, wherein the heat deforming step heats the prescribed regions of the second surface using the infrared light.

8. The nanoimprint method according to claim 6, comprising:
a measuring step for measuring measurement points set in the regions to be processed of the substrate, respectively; and
a step for calculating the deformation states of regions to be processed based on the measurement points;
wherein the heat deforming step heats the template, based on thermal expansion coefficient of the template, so as to conform to the deformation states of the regions to be processed.

9. The nanoimprint method according to claim 8, comprising: a step for calculating offset, rotation and orthogonality between the template and the regions to be processed based on the measurement points; and
an alignment step for performing alignment of the template and the substrate.

10. The nanoimprint method according to claim 5, comprising:
a curing step for curing the curable resin after the pressing step; and
a peeling step for peeling the template from the curable resin after the curing step.

11. A nanoimprint apparatus which presses a template, having a pattern with an uneven shape formed on a first surface thereof, to a substrate coated with a curable resin, the nanoimprint apparatus comprising:
a heating part which heats prescribed regions of a second surface which is opposite to the first surface; and
a pressing part which presses the pattern with the uneven shape, of the template which has been heated and thermally deformed, and regions to be processed of the substrate.

12. The nanoimprint apparatus according to claim 11, comprising:
a storage part which stores a coefficient indicating a relationship between thermal expansion coefficient of the template and an amount of heating; and
an operation part which computes a required heat amount required for thermally deforming the template;
wherein the heating part performs the heating based on the required heat amount.

13. The nanoimprint apparatus according to claim 11, wherein the heating part includes:
a heating light source which emits heating light;
a plurality of optical fibers which extend from the heating light source to the second surface; and
switches each of which is arranged in an intermediate portion of one of the optical fibers and performs ON/OFF switching of the light from the light source.

14. The nanoimprint apparatus according to claim 13, comprising an ultraviolet light irradiating part which irradiates ultraviolet light from the second surface of the template;
wherein after the plurality of optical fibers extending to the second surface are withdrawn from the template, the ultraviolet light irradiating part irradiates ultraviolet light to the template.

15. The nanoimprint apparatus according to claim 11 or claim 11, wherein the heating part includes:
a heating light source which emits heating light; and
a spatial light modulation part having a large number of reflecting elements arranged in a matrix shape and reflecting the light from the heating light source.

16. The nanoimprint apparatus according to claim 11, wherein the heating part includes:
a heating light source which emits heating light; and
a spatial light modulation part which has a large number of variable transmittivity elements arranged in a matrix shape and which allows the light from the heating light source to pass therethrough.

17. The nanoimprint apparatus according to claim 15, comprising:
an ultraviolet light irradiating part which irradiates ultraviolet light from the second surface of the template; and
an optical element which synthesizes a ultraviolet light optical path for the ultraviolet light and a heating light optical path for the heating light.

18. The nanoimprint apparatus according to claim 11, wherein the uneven shape of the template is formed to be reduced from a design value of the regions to be processed.

19. A nanoimprint apparatus comprising:
a template on which an uneven pattern is formed;
a substrate mounting stage which is arranged to face the template and on which a substrate coated with a liquid resin is mounted;
a pressing part which brings closely the template and the substrate in contact with each other and which presses at least one of the template and the substrate so that the resin is molded to the uneven pattern; and
a gas supply part which supplies gas, dissolving easily in the resin, when the template and the substrate are made to approach closely to each other by the pressing part, the gas being supplied to at least between the template and the substrate which faces the template.

20. The nanoimprint apparatus according to claim 19, wherein the substrate mounting stage and the template move relative to each other in a prescribed moving direction; and
the gas supply part is arranged at a front side of the prescribed moving direction.

21. The nanoimprint apparatus according to claim 19, comprising a resin coating part which performs coating of the liquid resin;
wherein the gas supply part is arranged between the template and the resin coating part.

22. The nanoimprint apparatus according to claim 19, wherein the gas supply part is arranged in the vicinity of the template.

23. The nanoimprint apparatus according to claim 11, wherein the gas supply part supplies any one of a gas with a lower molecular weight than air or a vapor of an organic solvent of the resin, the air having nitrogen and oxygen as main components thereof.

24. The nanoimprint apparatus according to claim 19, comprising a chamber which accommodates the template and the gas supply part and which reduces a pressure to be lower than that of external atmosphere.

25. A nanoimprint apparatus comprising:
a template on which an uneven pattern is formed;
a substrate mounting stage which is arranged to face the template and on which a substrate coated with a liquid resin is mounted;
a pressing part which brings closely the template and the substrate into contact with each other and which presses at least one of the template and the substrate so that the resin is molded to the uneven pattern; and
a chamber in which a gas dissolving easily in the resin is filled and which accommodates the template and the substrate.

26. The nanoimprint apparatus according to claim 19, comprising a curing part which cures the resin after the resin has been molded to the uneven pattern.

27. A nanoimprint method for transferring, to a substrate, an uneven pattern formed on a template, the method comprising:
a coating step for coating a liquid resin to the substrate;
a supply step for supplying a gas, which dissolves easily in the resin, to at least to a space between the template and the liquid resin facing the template; and
a pressing step for pressing at least one of the template and the substrate so as to mold the resin to the uneven pattern.

28. The nanoimprint method according to claim 27, wherein the supply step supplies the gas when the template and the substrate move relative to each other in a prescribed direction.

29. The nanoimprint method according to claim 27, wherein the supply step supplies the gas when pressing at least one of the template and the substrate.

30. The nanoimprint method according to claim 27, wherein the coating step coats the resin to the substrate within a pressure reduced chamber.

31. The nanoimprint method according to claim 27, wherein the supply step supplies any one of a gas with a lower molecular weight than air and a vapor of an organic solvent of the resin, the air having nitrogen and oxygen as main components thereof.

32. A nanoimprint method for transferring, to a substrate, an uneven pattern formed on a template, the method comprising:
a coating step for coating a liquid resin to the substrate;
a supply step for supplying a gas, which dissolves easily in the resin, into a chamber; and
a pressing step for pressing at least one of the template and the substrate so as to mold the resin to the uneven pattern.

33. The nanoimprint method according to claim 27, wherein the resin is cured after the resin has been molded to the uneven pattern and after gas bubbles have been eliminated from the resin.

34. The nanoimprint apparatus according to claim 19, wherein the gas supply part supplies any one of a gas with a lower molecular weight than air or a vapor of an organic solvent of the resin, the air having nitrogen and oxygen as main components thereof.

35. The nanoimprint apparatus according to claim 25, comprising a curing part which cures the resin after the resin has been molded to the uneven pattern.

36. The nanoimprint method according to claim 32, wherein the resin is cured after the resin has been molded to the uneven pattern and after gas bubbles have been eliminated from the resin.
